(19) United States
(12) Patent Application Publication
(10) Pub. No.: US 2007/0025047 A1
(43) Pub. Date: Feb. 1, 2007

(54) Electromagnetic valve actuator with a permanent magnet

(76) Inventor: Christophe Maerky, Saint-Ouen L'Aumone (FR)

Correspondence Address: BIRCH STEWART KOLASCH & BIRCH, PO BOX 747, FALLS CHURCH, VA, 22040-0747, US

(21) Appl. No.: 10/540,017

(22) PCT Filed: Dec. 19, 2003
(86) PCT No.: PCT/FR03/03808

§ 371 Date: Oct. 3, 2006

(30) Foreign Application Priority Data
Dec. 23, 2002 (FR) 0216518

(51) Int. Cl. H01H 47/00

(52) U.S. Cl. 361/160

(57) ABSTRACT

The invention relates to an electromagnetic valve actuator comprising an actuator member (11, 14) movable under the effect of a resilient member (12, 13) and of at least one coil (20), and at least one permanent magnet (22) arranged to hold the actuator member (11, 14) in at least one of its extreme positions against the resilient member (12, 13) when the coil (20) is not powered, the coil (20) being associated with a core (16) comprising two portions (17) having respective first facets (21) in contact with the permanent magnet (22) and respective second facets (23) that present between them an airgap (e) of size that is much smaller than a thickness (H) of the permanent magnet. According to the invention, the airgap (e) forms an angle with the direction (25) of magnetization of the permanent magnet (22).

The invention relates to an electromagnetic valve actuator with a permanent magnet.

### BACKGROUND OF THE INVENTION

An electromagnetic valve actuator is known, e.g. from document JP-A-08 004546, that comprises an actuator member movable under the effect of a resilient member and at least one coil, and at least one permanent magnet arranged in such a manner as to retain the actuator member in at least one of its extreme positions against the resilient member when the coil is not powered. The coil is associated with a core comprising two portions having respective first facets in contact with the permanent magnet. One of the core portions includes a projection which extends parallel to the direction of magnetization of the magnet towards the other core portion so as to define on the two core portions respective second facets that are spaced apart by an airgap of size that is much smaller than the thickness of the permanent magnet.

The projection forms a bypass that channels the major fraction of the flux from the coil, with only residual flux passing through the permanent magnet, thereby protecting it from the risk of demagnetization.

In that arrangement, the second facets extend adjacent to the side of the permanent magnet in a direction parallel to the first facets, such that the airgap extends parallel to the direction of magnetization of the permanent magnet.

That disposition has the drawback of increasing the size of the actuator in a direction perpendicular to the direction of magnetization of the permanent magnet.

### OBJECT OF THE INVENTION

An object of the invention is to provide an electromagnetic valve actuator having a permanent magnet and a bypass that presents reduced size.

### BRIEF SUMMARY OF THE INVENTION

The invention proposes a valve actuator of the above-specified type, in which the airgap between the second facets of the two core portions forms an angle with the direction of magnetization of the permanent magnet.

Thus, the increase in size is reduced to the size of the projection of the airgap onto the plane of the first facets.

In a preferred embodiment of the invention, the airgap forms a right angle with the direction of magnetization of the permanent magnet. This enables the bypass to be made without any increase in size.

### BRIEF DESCRIPTION OF THE DRAWINGS

The invention will be better understood in the light of the following description made with reference to the figures of the accompanying drawings, in which:

FIG. 1 is a section view of an actuator of the invention installed on an engine cylinder head, showing the magnetic flux traveling through the actuator during a stage in which the armature is being attracted towards the core;

FIG. 2 is a view analogous to FIG. 1, showing the magnetic flux traveling through the actuator while the armature is being held; and

FIG. 3 is a view analogous to FIG. 1, showing the magnetic flux traveling through the actuator while the armature is being separated from the core.

### DETAILED DESCRIPTION OF THE INVENTION

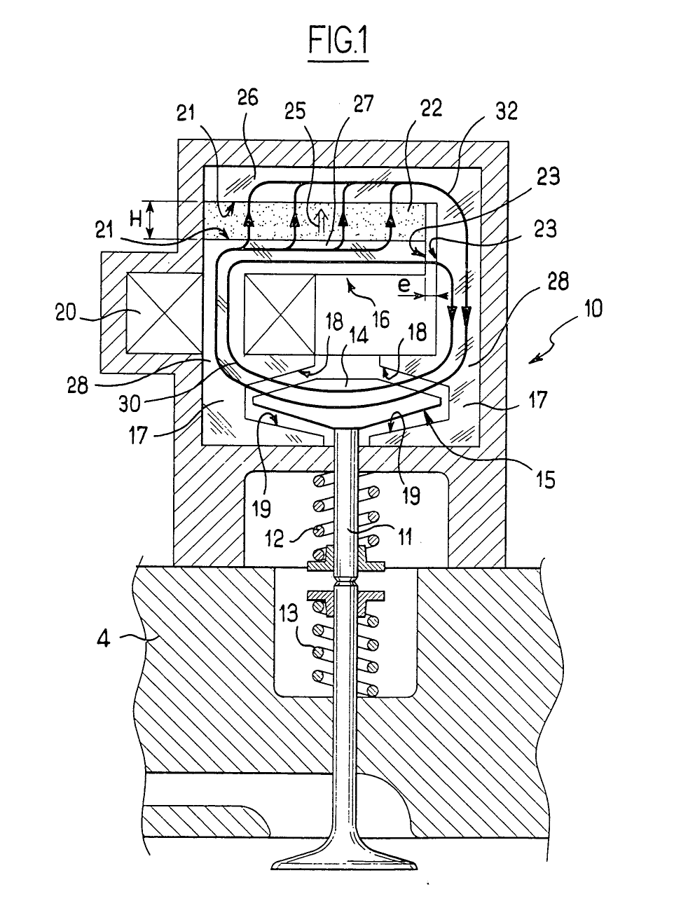

With reference to FIG. 1, the actuator 10 of the invention comprises a non-magnetic housing mounted on a cylinder head 4 of an engine in order to actuate a valve 1.

The actuator 10 comprises a pusher 11 which slides on the same axis as the stem of the valve 1. The end of the stem of the valve 1 and the end of the pusher 11 are urged towards each other by two opposing springs 12 and 13 acting respectively on the pusher 11 and on the stem of the valve 1. The springs 12 and 13 define an equilibrium position for the pusher 11, in which position the valve is half open.

The pusher 11 is secured to an armature 14, made of ferromagnetic material and movable inside a cavity 15 made in a ferromagnetic core 16 made up of two core portions 17. The cavity 15 defines a top active face 18 and a bottom active face 19, each active face extending over both core portions 17. When the armature 14 is in a position close to one or the other of the extreme positions, which correspond to the valve being in an open or a closed position, the armature 14 presents an airgap that is zero or very small relative to the corresponding active face.

In the embodiment shown, the actuator has a single coil, and one of the core portions 17 extends through the single coil 20.

In addition, the two core portions 17 have firstly first facets 21 that are in contact with the faces of a permanent magnet 22, and secondly second facets 23 that face each other with an airgap e that is very much smaller than the height H of the permanent magnet 22.

The actuator operates as follows.

It is assumed that the armature 14 is closer to the top active face than it is to the bottom active face such that initially the magnetic flux which is looped through the armature passes via the top active face. When, during its travel, the armature comes closer to the bottom active face, the magnetic flux loops through the armature by passing via its bottom active face, thereby attracting the armature towards said face.

In order to attract the armature 14 towards the top active face, the coil 20 is powered so as to generate magnetic flux 30 in the same direction as the magnetic flux 32 of the permanent magnet 22, as shown in FIG. 1.

The magnetic flux 30 generated by the coil 20 passes through the armature 14 via the top active face 18 and transits from one core portion to the other by passing almost completely through the second facets 23 because of the very small airgap e between the second facets 23 compared with the distance H between the first facets 21.

The magnetic flux 30 generated by the coil 20 adds its effects to the magnetic flux 32 generated by the permanent magnet 22, which flux, when the airgap between the armature 14 and the top active face 18 becomes less than the airgap e, passes through the core portions 17 via the first facets 21 and loops in the armature 14. At the end of the stroke, when the armature 14 is close to the top active face 18, power to the coil 20 can be interrupted or even reversed in order to control the speed at which the armature 14 docks against the top active face 18.

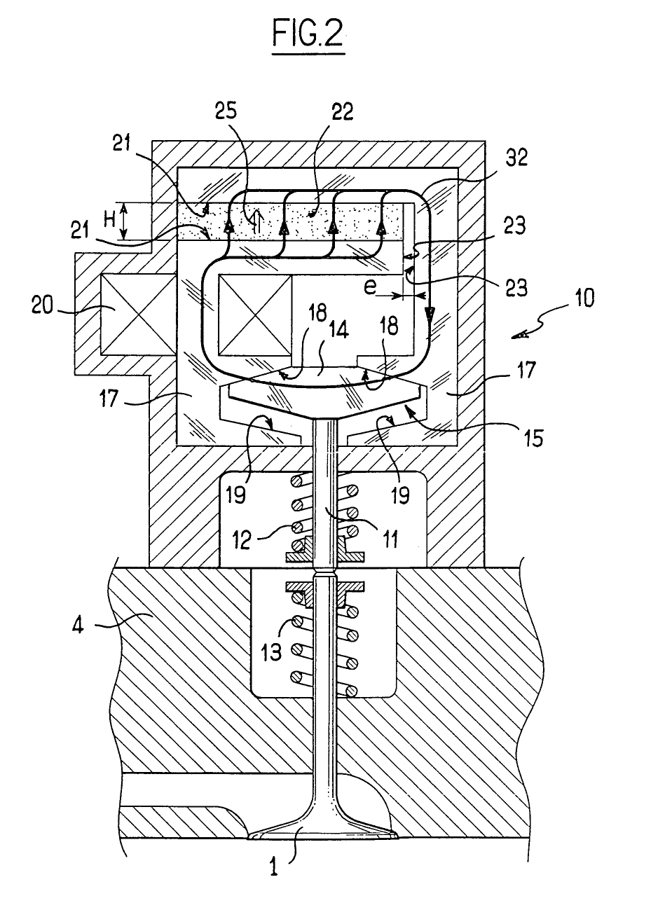

As can be seen in FIG. 2, once the armature is in abutment against the top active face 18, the magnetic flux 32 from the permanent magnet 22 is strong enough to hold the armature 14 in abutment against the top active face 18 against the spring 12.

In this respect, the active face portions in contact with the armature present areas that are smaller than the areas of the faces of the permanent magnet 22, thereby concentrating flux and tending to increase the force of attraction exerted by the permanent magnet 22 on the armature 14.

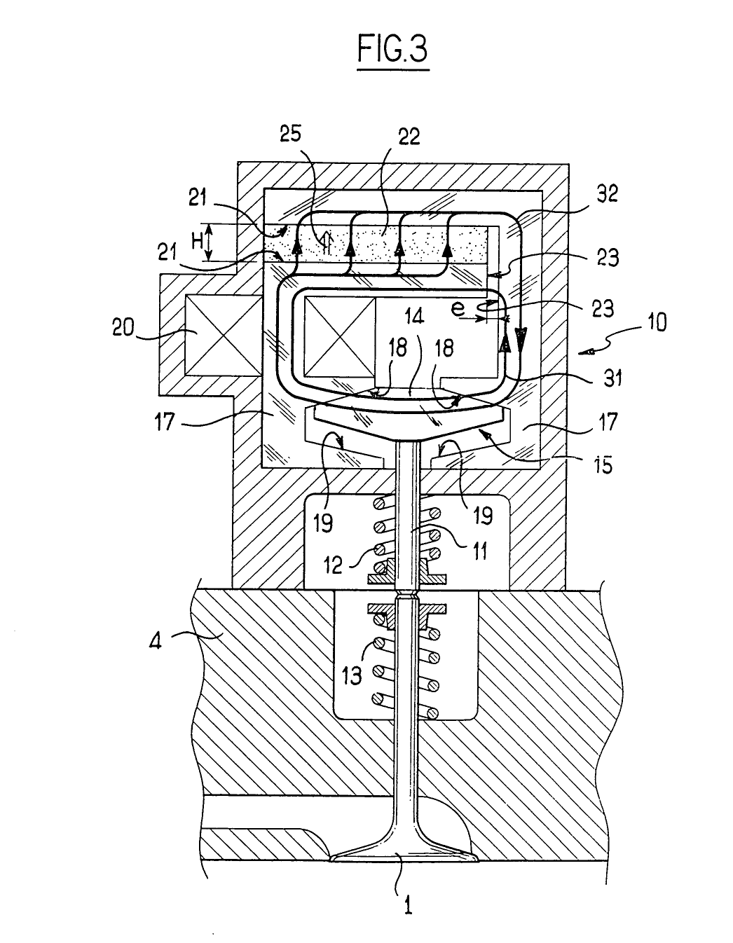

To separate the armature 14, as shown in FIG. 3, the coil 20 is powered so as to generate magnetic flux 31 in the opposite direction, opposing the magnetic flux 32 generated by the permanent magnet 22. The opposite magnetic flux 31 generated by the coil 20 thus loops in the opposite direction to that shown in FIG. 1, and thus cancels at least part of the flux 32 of the permanent magnet 22 so that the force of attraction exerted on the armature 14 is no longer sufficient to counter the force from the spring 12. The armature 14 then leaves the top active face 18.

In a valve actuator of the invention, the flux generated by the coil 20, whether in the same direction or in the opposite direction to the flux 32 of the permanent magnet 22 thus passes via the second facets 23 which thus form a magnetic path in the core 16 for said flux so that it does not pass through the permanent magnet 22 (ignoring losses).

The permanent magnet 22 is thus subjected, at worst, only to a marginal fraction of the flux generated by the coil 20, with this marginal fraction being in any event well below the flux needed to demagnetize the permanent magnet 22, even when the coil 20 is powered at high current levels.

According to an important aspect of the invention, the airgap e needs to be large enough to prevent the flux from the permanent magnet looping via the second facets 23, but small enough to reduce the losses of flux from the coil that pass via the first facets and through the permanent magnet.

According to a particular aspect of the invention, the second facets 23 are disposed in this case relative to the permanent magnet in such a manner that the airgap e is perpendicular to the direction 25 of magnetization of the permanent magnet 22. In the embodiment shown, the second facets 23 extend towards the inside of the actuator 10. The first facets and the second facets 23 thus extend perpendicularly relative to one another.

This disposition enables the actuator to house first facets 21 and second facets 23 that are of sufficient area to allow high levels of magnetic flux to pass, while not increasing the overall size of the actuator. In this context, it should be observed that there is no need for the second facets 23 to be perpendicular to the first facets 21; on the contrary they may form any angle that is adapted to the shape of the core so as to obtain the desired areas for each of them.

In the embodiment shown, it should be observed that the magnet extends parallel to the plane via which the actuator is engaged on the cylinder head 4, between a top horizontal branch 26 and a bottom horizontal branch 27 belonging to respective ones of the core portions 17 and each carrying one of the first facets 21. Each of the horizontal branches is connected via a generally L-shaped configuration to a vertical branch 28 whose bottom end is shaped to present the top and bottom active faces 18 and 19.

The permanent magnet 22 thus presents a width that is substantially equal to the width of the core, minus only the thickness of the vertical branch connected to the top horizontal branch and clearance corresponding to the airgap e. This disposition confers particularly large dimensions on the first facets 21 in contact with the permanent magnet 22.

The invention is not limited to the particular embodiment described above, but on the contrary covers any variant coming within the ambit of the invention as defined by the claims.

In particular, although the invention is shown with reference to a single coil actuator having an armature that is displaced linearly, the invention also applies to a single-coil actuator having an armature that is displaced in rotation, and also to actuators having two coils associated with an armature that is displaced linearly or in rotation, in which at least one coil is associated with at least one permanent magnet and with a core that defines a magnetic path for the magnetic flux from the coil that passes outside the permanent magnet.

1. An electromagnetic valve actuator comprising an actuator member (11, 14) movable under the effect of a resilient member (12, 13) and of at least one coil (20), and at least one permanent magnet (22) arranged to hold the actuator member (11, 14) in at least one of its extreme positions against the resilient member (12, 13) when the coil (20) is not powered, the coil (20) being associated with a core (16) comprising two portions (17) having respective first facets (21) in contact with the permanent magnet (22) and respective second facets (23) that present between them an airgap (e) of size that is much smaller than a thickness (H) of the permanent magnet, wherein the airgap (e) forms an angle with the direction (25) of magnetization of the permanent magnet (22).

2. An electromagnetic actuator according to claim 1, wherein the airgap (e) forms a right angle with the direction (25) of magnetization of the permanent magnet (22).
